(19) United States
(12) Patent Application Publication
(10) Pub. No.: US 2024/0393247 A1
(43) Pub. Date: Nov. 28, 2024

(54) Spatiotemporal Multiplexing Module

(71) Applicant: THE ROCKEFELLER UNIVERSITY, NEW YORK, NY (US)

(72) Inventors: Alipasha VAZIRI, Greenwich, CT (US); Jeffrey Dakin DEMAS, Astoria, NY (US)

(73) Assignee: The Rockefeller University, NEW YORK, NY (US)

(21) Appl. No.: 18/557,187

(22) PCT Filed: May 5, 2022
(86) PCT No.: PCT/US2022/027840

§ 371 Date: Oct. 25, 2023

Related U.S. Application Data
(60) Provisional application No. 63/184,754, filed on May 5, 2021.

(51) Int. Cl. G01N 21/64; G01N 21/47; G02B 21/00; G02B 21/16; G02B 27/14

(52) U.S. Cl. CPC G01N 21/6458; G01N 21/6408; G02B 27/14; G01N 21/4795; G01N 2021/6469; G02B 21/002; G02B 21/16; G02B 2207/114

(57) ABSTRACT

A multiplexing module implements receiving a plurality of laser pulses from a pulsed laser source via an input coupler element; splitting each laser pulse into a plurality of beamlets; introducing a delay between adjacent beamlets of the plurality of beamlets; and outputting a plurality of beamlets associated with each respective laser pulse via an output coupler element, wherein the input coupler and the output coupler are separate elements of the multiplexing module.

### CROSS-REFERENCE TO RELATED APPLICATIONS

This application is a US National Stage of PCT application Serial No. PCT/US2022/027840, filed on May 5, 2022, which claims priority from U.S. provisional application Ser. No. 63/184,754, filed on May 5, 2021, the specifications of which are incorporated herein by reference.

### BACKGROUND

Two-photon (2p) scanning microscopy paired with genetically encoded Calcium indicators (GECIs) has become the gold-standard for recording activity, particularly at depth, in scattering brain tissue. However, 2p microscopy systems are still limited in both volumetric field-of-view (FOV) and recording speed by the need to scan a small, focused beam to form an image. To begin to understand the underlying cortical circuitry behind emergent, complex behavior in human-analogous models, tools are required that can record the activity of single neurons, across depth, and in multiple cortical areas simultaneously.

Current state-of-the-art scanning techniques face a number of technical limitations related to large-scale functional imaging of the mammalian brain. Understanding how sensory information and behavioral states are encoded within the mammalian brain requires the ability to record the activity of large populations of individual neurons distributed across functional and anatomical regions that span the entire cortex in awake and behaving animals. However, the inherent tradeoffs among imaging speed (i.e., voxel acquisition rate), spatial resolution, signal to noise ratio (SNR) and the size of the recording volume, and the finite limits of brain exposure to laser power have prevented the realization of a mesoscopic-scale volumetric imaging of single neuron activity across different layers of the entire cortical surface at adequate physiological volume rates. Solving this engineering challenge within the constrained and highly interrelated parameter space necessitates a principled approach that thus far has been missing in previous realizations of calcium (Ca2+) imaging. Hence, there is a need for improved systems and methods that provide a technical solution for overcoming the inherent tradeoffs a speed, resolution, and acquisition volume-size of current scanning techniques.

### SUMMARY

An example multiplexing module according to the disclosure is configured to perform operations of: receiving a plurality of laser pulses from a pulsed laser source via an input coupler element; splitting each laser pulse into a plurality of beamlets; introducing a delay between adjacent beamlets of the plurality of beamlets; and outputting a plurality of beamlets associated with each respective laser pulse via an output coupler element, wherein the input coupler and the output coupler are separate elements of the multiplexing module.

An example method of operating a multiplexing module according to the disclosure includes receiving a plurality of laser pulses from a pulsed laser source via an input coupler element; splitting each laser pulse into a plurality of beamlets; introducing a delay between adjacent beamlets of the plurality of beamlets; and outputting a plurality of beamlets associated with each respective laser pulse via an output coupler element, wherein the input coupler and the output coupler are separate elements of the multiplexing module.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram showing an example implementation of a spatiotemporal multiplexing module that may be used to implement the Many-Fold Axial Multiplexing (MAxiMuM) module described herein.

FIG. 2 is a diagram showing an example implementation of an alternative configuration of the spatiotemporal multiplexing module that may be used by MAxiMuM.

FIG. 3 is a diagram of an example microscopy setup in which MAxiMuM in integrated with a mesoscope.

FIG. 4 is a flow diagram of an example process for operating a multiplexing module.

FIG. 5 is a block diagram illustrating an example software architecture, various portions of which may be used in conjunction with various hardware architectures herein described, which may implement any of the features herein described.

FIG. 6 is a block diagram illustrating components of an example machine configured to read instructions from a machine-readable medium and perform any of the features described herein.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Techniques for operating a multiplexing module for volumetric sampling are provided. These techniques provide a technical solution for overcoming the inherent tradeoffs of speed, resolution, and acquisition volume-size of current scanning technique with a Many-Fold Axial Multiplexing (MAxiMuM) module for volumetric sampling. The MAxiMuM module optimizes temporal and spatial sampling in combination with spatiotemporal axial or lateral multiplexing, to facilitate fully volumetric imaging through 2D scanning. MAxiMuM may be applied to Calcium (Ca²⁺) imaging, voltage imaging, and/or other types of imaging. Furthermore, while the example implementations described herein are related to imaging, MAxiMuM may also be applied to non-imaging applications, such as but not limited to 2p photopolymerization. These and other technical benefits of the techniques disclosed herein will be evident from the discussion of the example implementations that follow.

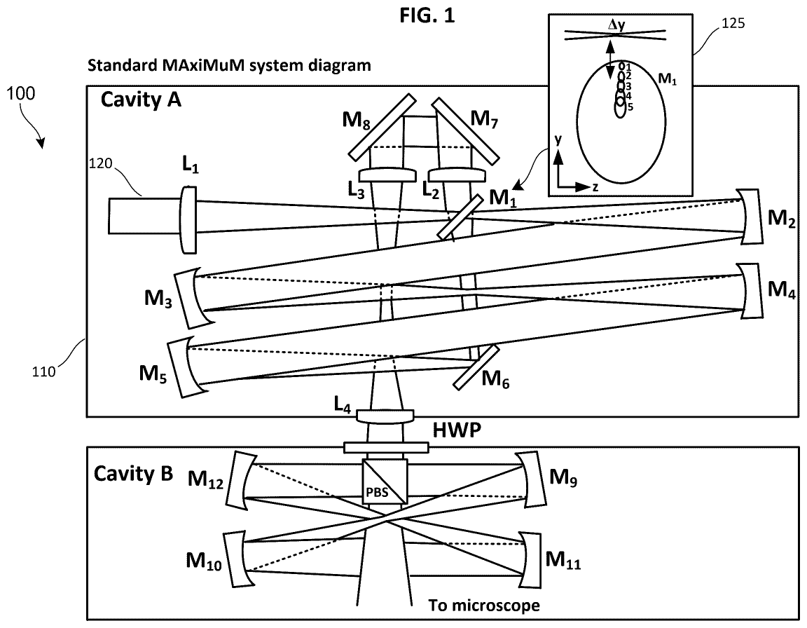

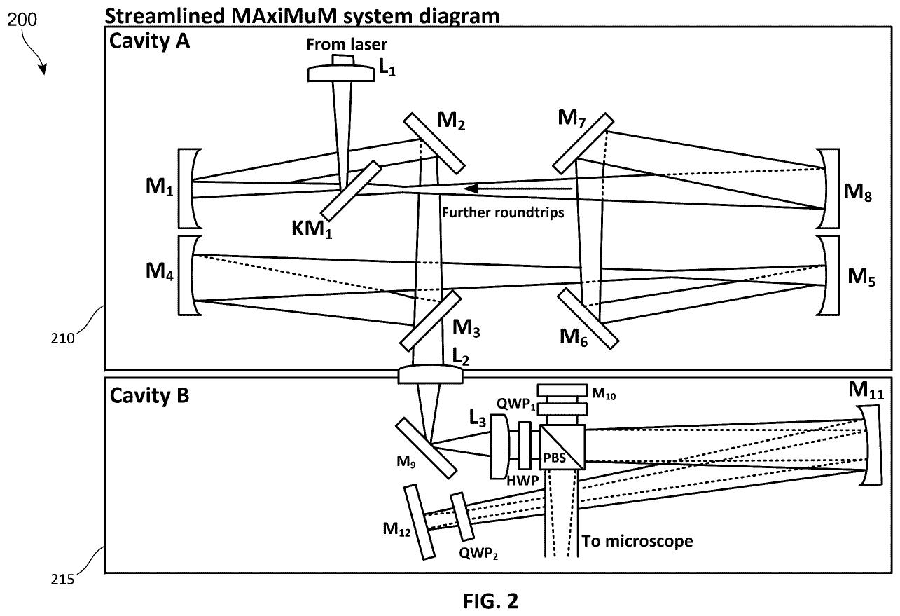

The MAxiMuM module facilitates directing a high multiplicity of beamlets toward different axial planes in a given sample volume. For example, one implementation may be used to direct approximately 30 beamlets toward different axial planes of the sample volume. Other implementations may direct a different number of beamlets toward axial planes of the sample volume. Furthermore, the MAxiMuM module introduces a delay between beamlets. The beamlets are each delayed with respect to one another so that resultant fluorescence signals are distinguishable in time-leading to an order of magnitude increase in volumetric sampling. Crucially, these properties can be achieved using a relatively low number of components to make the system complexity and alignment reasonable to maintain. Updates to the original MAxiMuM cavity design are highlighted herein that improve performance, case of alignment, and stability so that the module can be more easily replicated by other investigators. FIG. 1 provides an example of implementation of a MAxiMuM module, and FIG. 2 and the provides an example implementation that introduces additional improvements to the cavity design.

The MAxiMuM module provides a technical solution to the technical problem of overcoming the inherent tradeoffs between speed, resolution, and acquisition volume-size of current scanning techniques. The technical solution provides an optimized spatial and temporal sampling strategy that maximizes extraction fidelity for objects of interest in a sample within a finite power budget and a spatiotemporal multiplexing module for sampling axially without the need for axial scanning. The MAxiMuM module is a scalable solution that further provides the ability to control the pulse energy of each of a set of beamlets in a relatively lossless manner. Furthermore, the pulse energy of each beamlet may be arbitrarily set.

The MAxiMuM module may generate a set of axially or laterally separated and temporally distinct foci referred to herein as “light beads” corresponding to the beamlets. These light beads may be used to in axial scanning to rapidly record information throughout the entire depth of the sample at the same time and at a rate that often exceeds the rate at which current microscopes record a single voxel on a single axial plane of a sample. As a result, the imaging techniques provided herein may scan an entire volume in the same amount of time that current microscopes take to scan a single axial plane of a sample, because the spatiotemporal multiplexing module facilitates simultaneous scanning across multiple axial planes of the sample. Alternatively, the light beads may be used to laterally scan across multiple sampling locations of a lateral plane of the sample rather than across multiple axial planes of the sample.

Conventional volumetric scanning 2p microscopes scan along the optical axis. This approach requires scanning of each plane in the volume sequentially, and thus severely limits the obtainable volumetric acquisition rate. The MAxiMuM module provides a technical solution to this problem by eliminating axial scanning and instead sampling along the axis through a series of 30 spatiotemporal multiplexed beamlets. While the example implementation discussed herein utilize 30 spatiotemporal multiplexed beamlets, other implementations may be configured to utilize a different number of beamlets. Each voxel in a MAxiMuM data set corresponds to a single beamlet or bead, thereby maximizing signal-to-noise ratio while minimizing heat penalty.

In conventional volumetric scanning 2p microscopes without the MAxiMuM module, the laser may have a relatively slow repetition rate, which could result in dead time between voxels. For example, if the laser has a repetition rate of 4.68 MHZ, this will result in approximately 214 ns of dead time between voxels. To address this technical problem, MAxiMuM provides a spatiotemporal multiplexing module to split a single pulse from the laser into multiple beamlets which are each delayed such that they may be equally spaced in time across a time window. For example, the spatiotemporal multiplexing module may be configured to split a single pulse of the laser into 30 beamlets and to delay each beamlet such that the beamlets are equally spaced in time across the 214 ns window for the laser having a 4.68 MHz repetition rate. The number of beamlets and the size of time window may vary depending upon the implementation. Additionally, each beamlet is given a different divergence during the splitting process to focus each beamlet to a different axial plane of the sample. A technical benefit of this approach is that, based on the time of arrival to the detector, light resulting from excitation of the sample can be binned and re-assigned to the plane from which the light originated. This light may result from fluorescence of an indicator applied to the sample which is excited by the laser light of a beamlet. Another technical benefit of this approach is that an entire column is sampled within the time that it would have normally taken to record a single pixel laterally. Thus, the volume can be imaged at the planar frame rate of the mesoscope.

FIG. 1 provides an example implementation of a spatiotemporal multiplexing module 100 that may be used to implement MAxiMuM. The spatiotemporal multiplexing module 100 may be based on an 8f re-imaging cavity constructed with concave mirrors and/or with a combination of flat mirrors and lenses. The round-trip time of the cavity provides temporal delay between beamlets, and an offset between the plane where the beam is re-imaged by the concave mirror pairs and the partially reflective mirror which re-injects beams back into the cavity results in an increase in divergence for each beam exiting the cavity. In one implementation, the axial offset of the cavity is configured such that the 30 beams cover an axial extent of 450 μm in a sample, corresponding to ˜15 μm axial sampling.

In FIG. 1, ‘Ms’ denote mirrors, ‘Ls’ denote lenses, and ‘HWP’ denotes a half-wave plate. The cavity of the spatiotemporal multiplexing module 100 reimages the focused beam from a pulsed laser source using four concave mirrors. A partially reflective mirror (PRM) is used as both an input coupler and an output coupler. The PRM is disposed before the cavity to reflect the majority of light back into the cavity for the subsequent round trips while the chosen fraction of the light (also referred to herein as a “beamlet”) is coupled out of the cavity and sent towards the microscope. Each roundtrip introduces a lateral offset Δy and an axial offset Δz, and a temporal offset Δt for each successive beam. The relative pulse energy for each beamlet may be set by adjusting the splitting ratio of the PRM.

The beam propagates a distance Δz from the nominal focal plane before encountering the PRM partially reflective mirror. The reflected portion is reintroduced into the cavity and for each successive round-trip experiences an extra axial shift Δz and a relative temporal delay Δt. Accordingly, the beams transmitted out of the cavity have distinct axial focal points (z1, z2, . . . z30) and distinct temporal delays (t1, t2, . . . t30). To be incident on the partially reflective mirror after the first roundtrip, spatiotemporal multiplexing module 100 also imparts a small lateral shift as well, resulting in slight tilt to the light column and a total lateral separation of <200 μm between the top and bottom beads in the sample.

The introduced focal offset between each beam allows the beams to focus to depths in the sample with a relative decrease in optical power for the i^{th} given by Pᵢ=T(1−T)ⁱ, with T the transmission of the PRM while the size and geometry of the cavity allows for the temporal separation of sub-pulses to be adjusted to fulfill the fluorescence lifetime limited principle. The above equation shows that T can be chosen to match the exponential power change to the specific scattering length of the imaged sample. A technical benefit of this approach is that it provides a flexible means for adjusting the power such that the power increases in subsequent light beads as a function of sample depth and independently of the axial separation of the light beads in the scattering sample. An example implementation of MAxiMuM using a mirror with T˜8% allows the generation of 30 temporally multiplexed beams, such as those shown in the example of FIG. 1.

One of the technical benefits of the MAxiMuM techniques provided herein, is that it allows for a decoupling of the number of axially multiplexed beams and the sample-specific needs to adjust the power as a function of depth in order to maintain a constant SNR. Another technical benefit of this versatility is that MAxiMuM enables the realization of sampling conditions at different densities and axial imaging ranges within the same sample which in turn enables the realization of imaging modalities with different applications. More specifically, this decoupling allows the axial separation between the foci of two sequential beams in the sample, δz, to be freely chosen by fulfilling δz=−lₛ In (1−T) with δz=Δz/M² where M is the magnification of the microscope and Δz the axial separation of beams exiting the cavity. This degree of freedom together with the lateral voxel spacing given by the laser repetition rate, the resonant scanner frequency, the optical design of the system and the flexibility to choose size of the point-spread function (PSF) allows the effective realization of different imaging modalities aimed at large-scale cellular-resolution volumetric recording, synaptic resolution volumetric recording of dendrites and axonal processes and volumetric cellular resolution imaging at up to ˜400 Hz and beyond, which opens up applications of our approach to volumetric voltage imaging of genetically encoded voltage indicators (GEVIs).

The spatiotemporal multiplexing module 100 may be implemented as a standalone module that is disposed between a laser source and a microscope where the spatiotemporal multiplexing module 100 performs sequential re-imaging of the beam waist at the entrance of the spatiotemporal multiplexing module 100. As a result, the spatiotemporal multiplexing module 100 may be combined with existing 2 pM systems. By using appropriately selected cavity parameters and telescopes in addition to the demultiplexed detection, existing 2 pMs can be converted to fast volumetric Ca2+ imaging platforms with desired spatiotemporal resolution for different neurobiological applications provided that the laser source can produce sufficient pulse energies. Thereby, the spatiotemporal multiplexing module 100 addresses the inherent tradeoffs between volume acquisition rate, voxel spacing, and resolution within the limits of sample exposure to laser light in the most efficient manner irrespective of which parameter is optimized.

In the example implementation of the spatiotemporal multiplexing module 100 includes a cavity 110 that includes concave mirrors configured in an 8f, non-inverting, re-imaging scheme. However, other implementations may utilize a combination of flat mirrors and lenses to replace some or all the concave mirrors. An input beam 120 is focused by lens L₁, which is disposed above the aperture of the PRM M₁ and in front focal plane of the mirror M₂. The mirrors M₂, M₃, M₄, and M₅ are concave mirrors with low-dispersion dielectric coatings. The mirrors M₂, M₃, M₄, and M₅ reimage the initial spot of the laser pulse onto the turning mirror M₆. The mirror M₆ provides a slight vertical tilt to the beam such that it intersects the PRM M₁. The PRM M₁ is a low dispersion ultrafast beam splitter. The majority of the light incident on the PRM M₁ undergoes another round-trip through the cavity 110, and the rest of the light is output by the cavity 110. In implementations that include the optional cavity 115, the light output by cavity 110 is transmitted to cavity 115. Thus, a beamlet is split off from the laser light incident on the PRM M₁ and output from the cavity 110, while the remainder of the light incident on the PRM M₁ makes another round trip of the cavity 110.

Each round trip through the cavity 110 provides a temporal delay as well as an offset in the focal plane of the beam dictated by the distance between the mirror M₆ and the PRM M₁. In the example shown in FIG. 1, the temporal delay τ may be represented by the equation τ=8f/c. The angle of the mirror M₆ ensures that the beam 120 intersects the aperture of the PRM M₁ and causes a small lateral offset between subsequent round trips of the cavity 110. This offset is minimized during alignment to reduce offset between axial planes in the sample.

The non-zero transmission of the PRM M₁ also causes the beams emitted from the cavity 110 to fall off in optical power exponentially according to the splitting ratio of M 1. It is well known that scattering samples, such as brain tissue, requires an increase in imaging power to preserve signal to noise ratio at increasing sample depths. Accordingly, the spatiotemporal multiplexing module 100 can finely tune the rate of decrease in power between subsequent beams focused to different axial depths in the sample by manipulating the splitting ratio of the mirror M₁ in order to match the expected scattering properties of the tissue or other sample. Therefore, by orienting the least-powerful beams towards the shallowest depths in the sample to be scanned, the spatiotemporal multiplexing module 100 facilitates volumetric imaging without the need for active adjustment of the imaging power. Due to the shorter delay of cavity 115 relative to cavity 110, the pulse trains from cavity 110 and cavity 115 are interleaved. The pulse energies for each beam decreases exponentially according to the transmission/reflection ratio of mirror M₁ (a PRM) in cavity 110. The transmission/reflection ratio may be adjusted to control the pulse energy drop off of the individual beamlets. For brain tissues, exponential decrease may be matched to the expected scattering length (lₛ) for brain tissue (˜200 μm). The exponential decrease may be matched to the expected scattering length for other types of samples. Power of the pulses from cavity 115 is lower than those from cavity 110 since cavity 115 pulses are sent to more superficial layers in the sample. The offset can be controlled by the HWP in cavity 110.

In an example implementation of the spatiotemporal multiplexing module 100 used for 2 pM where the sample comprises brain tissue, excitation power must increase exponentially with depth to preserve signal-to-noise ratio in the presence of tissue scattering. The spatiotemporal multiplexing module 100 is configured such that the pulse energy for beams exiting the cavity fall off according to an exponential decay chosen by optimizing the partial reflectivity of the PRM M₁. Using a reflectivity of R=10% allows for a fall-off of pulse energy that matches the scattering length of brain tissue (lₛ˜ 200 μm), such that the signal-to-noise ratio from each light bead is conserved and maximized across all depths within the column for the total delivered pulse energy. A series of relay telescopes may be used to couple the light beads into a mesoscopy platform such that the center of the light bead column is conjugated to the nominal focal plane of the objective.

While the spatiotemporal multiplexing module 100 shown in FIG. 1 provides the numerous technical benefits discussed above, the spatiotemporal multiplexing module 200 shown in FIG. 2 provides an alternative implementation that refines aspects of the example implementation shown in FIG. 1. In the spatiotemporal multiplexing module 100 shown in FIG. 1, the PRM (M₁) is in focal space, which impacts the design of the spatiotemporal multiplexing module 100. First, the aperture of the optic quickly becomes a limiting factor for the multiplicity of beams in the cavity and the relative lateral offset (Δy) between successive round trips. The lateral offset between round trips is crucial to ensure that the beam can enter the cavity above M₁ but is incident on the aperture after M₆. Furthermore, due to the offset between the nominal focus of the reimaging mirrors at M₆ and the PRM M₁, the footprint of the beam on M₁ increases with each roundtrip (see inset schematic 125). A large lateral offset, a high multiplicity of beams, or a large focal offset can lead to vignetting on the aperture M₁. Additionally, since M₁ has a specialty coating, it is not available off the shelf as a knife edge component. Accordingly, the diameter of the part is significantly larger than the effective clear aperture, requiring a larger than optimum lateral offset between roundtrips to avoid clipping of the beam.

Another consideration for the cavity design is that the transmission of M₁ is controlled by the angle of incidence of the light impinging on its aperture. Decreasing this angle requires repositioning M₆ further away from M₅ such that illumination on M₁ is shallower. However, in the spatiotemporal multiplexing module 100 shown in FIG. 1, the focal offset in this design is dictated by the length of the path between M₅ to M₁, thus the cavity transmission and focal offset are coupled variables. This coupling may complicate the alignment and adjustment of the cavity performance.

Finally, the second cavity 115 in the spatiotemporal multiplexing module 100 shown in FIG. 1 uses a second set of mirrors with shorter focal lengths, also arranged in an 8f re-imaging configuration, to increase the multiplicity of the composite system. However, this geometry links the focal offset (M₉→M₁₀, M₁₁→M₁₂) to the distance between mirrors in afocal space (M₁₀→M₁₁). Accordingly, a positive focal offset leads to an unwanted deviation from the 2f condition in afocal space, resulting in a non-unity magnification for the cavity and an increase of the PSF size in the sample. Furthermore, aligning this cavity such that the output is colinear with the beams transmitted through the PBS may be difficult in practice.

The spatiotemporal multiplexing module 200 shown in FIG. 2 provides a technical solution to the technical problems discussed above regarding the spatiotemporal multiplexing module 100 shown in FIG. 1. In FIG. 2, ‘Ls’ denotes lenses, ‘Ms’ denotes mirrors, ‘KM’ denotes a knife edge mirror, ‘HWP’ denotes a half-wave plate, ‘QWP’ denotes a quarter-wave plate, and ‘PBS’ denotes a polarizing beam splitter. M₁, M₄, M₅, M₈, and M₁₁ are concave mirrors. In spatiotemporal multiplexing module 200, the PRM (M₃) has been moved into afocal space as shown in cavity 210 in FIG. 2. While the roundtrips have a lateral offset in focal space in the implementation shown in FIG. 2, in afocal space they are spatially overlapped (albeit with angular diversity in their propagation directions). Light escapes from the cavity 210 through a PRM (M₃) in afocal space, leading to less risk of vignetting on cavity optics. By placing the partially reflective mirror (M₃) in this new geometry, the demands on the aperture of the mirror are significantly reduced. Furthermore, the spatiotemporal multiplexing module 200 includes a mirror strictly for coupling the first beam into the cavity (KM₁), which is specifically chosen to be a knife edge mirror such that the lateral offset Δy can be minimized between roundtrips. This solution is more effective as a knife edge and larger aperture version of M₁ in the original cavity design would necessarily be a custom component with a higher cost and lead time than KM₁ and M₃ combined. Additionally, this knife edge mirror can be used to position the focused beam closer (z<<f) to the first cavity mirror (M₁) that the focal distance, effectively “biasing” the cavity such that the focused roundtrips are evenly distributed between the first and last cavity mirrors (M₁ and M₈). The focal offset in the new cavity design is dictated by the separations between M₄ to M₅ and M₈ to M₁ and independent of the angle on M₃. Thus, focal offset and cavity transmission are no longer coupled degrees of freedom in this new design. In principle, one half of the cavity (M₅ through M₈, for example) could be built on a translation stage to facilitate rapid tuning of the cavity focal offset. Finally, the doubling cavity 215 becomes a folded path using a single concave mirror (M₁₁), doubling the multiplicity of the system. This ensures that the path has unity magnification, uses less components (particularly less of the custom zero dispersion mirrors), and is easier to both align and adjust. With these improvements, the barriers for dissemination of the MAxiMuM module may be greatly reduced compared with other implementations.

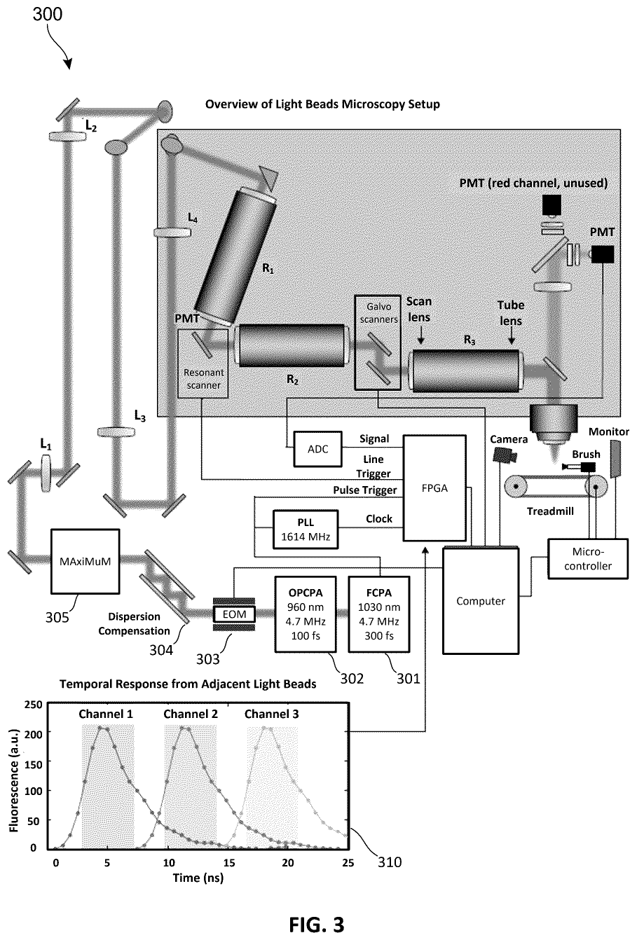

Integration with mesoscope: The MAxiMuM module 100 and the MAxiMuM module 200 shown in the preceding examples may be integrated with a commercial mesoscope. An example mesoscope layout and accompanying electronics are shown in FIG. 3.

FIG. 3 is a diagram providing an example mesoscopic system 300. The mesoscopic system 300 includes a fiber chirped-pulse amplifier (FCPA) 301 which emits the pulsed laser beam, which passes through the optical parametric chirped-pulse amplifier (OPCPA) 302 followed by the electro-optic modulator (EOM) 303, the dispersion compensation path 304, MAxiMuM 305, and into the microscope. ‘Ls’ denote lenses, ‘Rs’ denote relay lens pairs, ‘PMT’ denotes photo-multiplier tube, ‘ADC’ denotes analog to digital converter, and ‘PLL’ denotes phase-locked loop. The channel plot 310 shows channel allocation for demultiplexing on the Field Programmable Gate Array (FPGA). Data points are the measured impulse response for fluorescence from GCaMP6f measured with our PMT and associated electronics, captured with 1614 MHZ (0.62 ps) resolution. Shaded regions denote the integration boundaries for each demultiplexed channel.

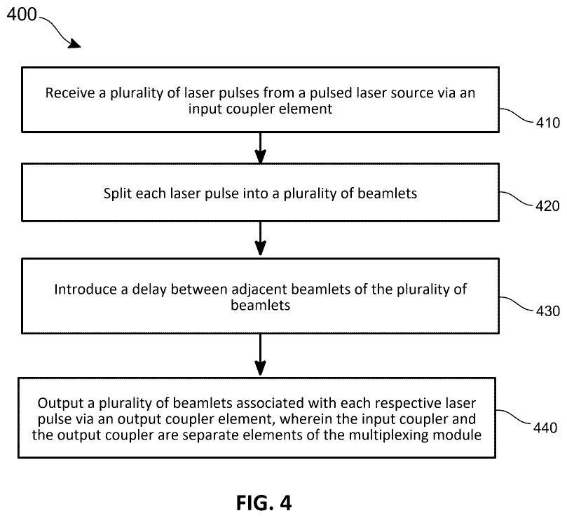

FIG. 4 is a flow diagram of an example process 400 for operating a multiplexing module. The processing 400 may be implemented using the spatiotemporal multiplexing module 200 shown in the preceding examples.

The process 400 may include an operation 410 of receiving a plurality of laser pulses from a pulsed laser source via an input coupler element. The knife edge mirror KM₁ serves as the input coupler in the spatiotemporal multiplexing module 200.

The process 400 may include an operation 420 of splitting each laser pulse into a plurality of beamlets. The spatiotemporal multiplexing module 200 splits a respective pulse from the laser into multiple beamlets as discussed in the preceding examples.

The process 400 may include an operation 430 of introducing a delay between adjacent beamlets of the plurality of beamlets. The spatiotemporal multiplexing module 200 delays the beamlets which are each delayed such that they may be equally spaced in time across a time window. The round-trip time of the cavity of the spatiotemporal multiplexing module 200 provides temporal delay between beamlets, and an offset between the plane where the beam is re-imaged by the concave mirror pairs and the partially reflective mirror which re-injects beams back into the cavity results in an increase in divergence for each beam exiting the cavity.

The process 400 may include an operation 440 of outputting a plurality of beamlets associated with each respective laser pulse via an output coupler element, wherein the input coupler and the output coupler are separate elements of the multiplexing module. As discussed in the preceding examples, the knife edge mirror KM₁ serves as the input coupler and is separate from the PRM M₃ which serves as the output coupler. Light escapes from the cavity 210 of the spatiotemporal multiplexing module 200, which leads to less risk of vignetting on cavity optics compared to the example spatiotemporal multiplexing module 100 shown in FIG. 1.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

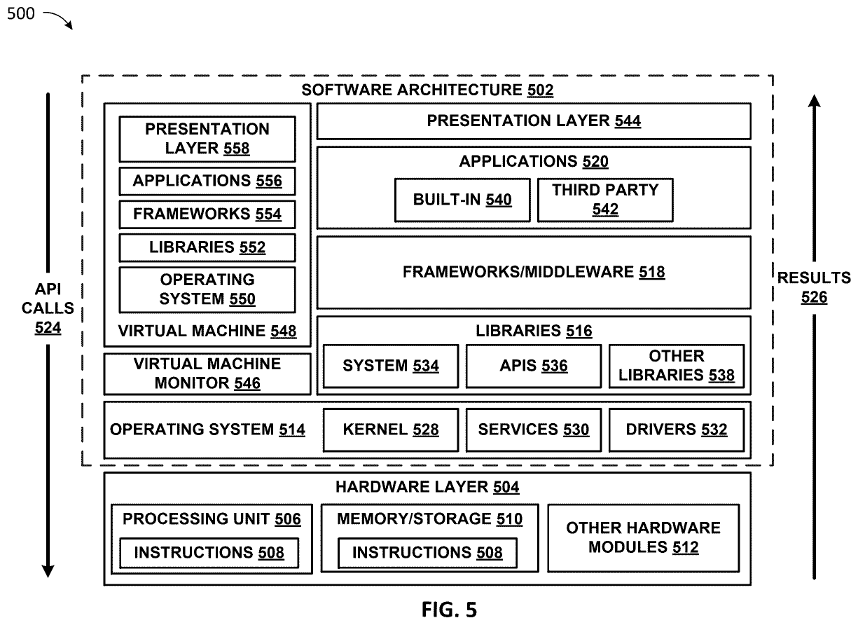

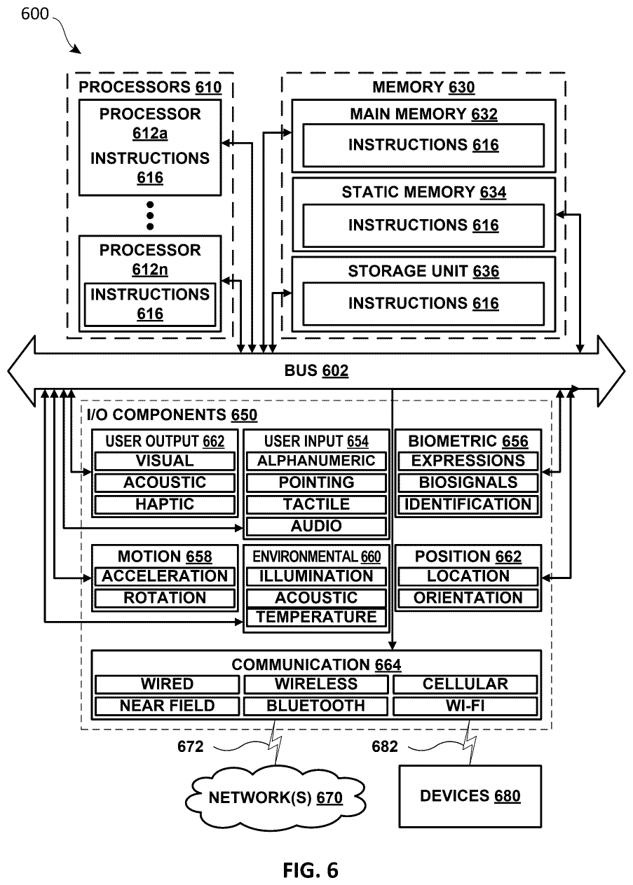

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 662, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A multiplexing module configured to perform operations of:
receiving a plurality of laser pulses from a pulsed laser source via an input coupler element;
splitting each laser pulse into a plurality of beamlets;
introducing a delay between adjacent beamlets of the plurality of beamlets; and
outputting a plurality of beamlets associated with each respective laser pulse via an output coupler element, wherein the input coupler and the output coupler are separate elements of the multiplexing module.

2. The multiplexing module of claim 1, wherein splitting each laser pulse into the plurality of beamlets comprises:
splitting each laser pulse into the plurality of beamlets using a beam splitter located in afocal space of the multiplexing module.

3. The multiplexing module of claim 2, wherein the beam splitter comprises a partially reflective mirror.

4. The multiplexing module of claim 2, wherein the beam splitter is the output coupler of the multiplexing module.

5. The multiplexing module of claim 1, wherein the multiplexing module is further configured to perform an operation of:
directing the plurality of laser pulses from the pulsed laser source into a first re-imaging cavity of the multiplexing module using a first mirror.

6. The multiplexing module of claim 5, wherein the first mirror is selected to minimize a lateral offset of adjacent beamlets.

7. The multiplexing module of claim 5, wherein the first mirror is a knife-edge mirror.

8. The multiplexing module of claim 5, wherein first re-imaging cavity comprises a series of mirrors, lenses, or a combination thereof disposed in a symmetric configuration.

9. The multiplexing module of claim 8, wherein the first re-imaging cavity comprises a first portion and a second portion, and wherein a focal offset of the multiplexing module is based on a separation between a first mirror of the first portion and a second mirror of the second portion.

10. The multiplexing module of claim 9, wherein a position of the first portion relative to the second portion of the first re-imaging cavity is adjustable to modify an axial separation and a temporal separation of the plurality of beamlets to be adjusted.

11. The multiplexing module of claim 10, wherein the second portion of the first re-imaging cavity is disposed on a translation stage, and wherein adjusting the position of the translation stage adjusts the position of the second portion of the first re-imaging cavity relative to the first portion of the first re-imaging cavity.

12. The multiplexing module of claim 5, wherein the multiplexing module comprises a second re-imaging cavity, and wherein outputting the plurality of beamlets associated with each respective laser pulse comprises outputting the plurality of beamlets from the first re-imaging cavity to the second re-imaging cavity.

13. The multiplexing module of claim 12, wherein the second-reimaging cavity includes a single concave mirror and a plurality of flat mirrors.

14. A method of operating a multiplexing module, the method comprising:
receiving a plurality of laser pulses from a pulsed laser source via an input coupler element;
splitting each laser pulse into a plurality of beamlets;
introducing a delay between adjacent beamlets of the plurality of beamlets; and
outputting a plurality of beamlets associated with each respective laser pulse via an output coupler element, wherein the input coupler and the output coupler are separate elements of the multiplexing module.

15. The method of claim 14, wherein splitting each laser pulse into the plurality of beamlets comprises:
splitting each laser pulse into the plurality of beamlets using a beam splitter located in afocal space of the multiplexing module.

16. The method of claim 15, wherein the beam splitter comprises a partially reflective mirror.

17. The method of claim 15, wherein the beam splitter is the output coupler of the multiplexing module.

18. The method of claim 14, wherein the multiplexing module is further configured to perform an operation of:
directing the plurality of laser pulses from the pulsed laser source into a first re-imaging cavity of the multiplexing module using a first mirror.

19. The method of claim 18, wherein the first mirror is selected to minimize a lateral offset of adjacent beamlets.

20. The method of claim 18, wherein the first mirror is a knife-edge mirror.
